(19) United States
(12) Patent Application Publication
(10) Pub. No.: US 2002/0191283 A1
(43) Pub. Date: Dec. 19, 2002

(54) Transmission projection screen

(76) Inventor: Gary A. Browning, Long Beach, CA (US)

Correspondence Address: KODA & ANDROLIA, Suite 3850, 2029 Century Park East, Los Angeles, CA, 90067-3024, US

(21) Appl. No.: 09/881,135

(22) Filed: Jun. 14, 2001

(51) Int. Cl. G03B 21/56

(52) U.S. Cl. 359/460

(57) ABSTRACT

A light transmission projection screen including a transparent lens sheet, a plurality of longitudinal spaced apart grooves provided in a front surface of the lens sheet, a plurality of flat portions in the front surface of the lens sheet between the plurality of spaced apart grooves, a transparent optical layer provided on an inner surface of each of the V grooves, an optically opaque material filling only the grooves and a diffusion layer provided on the front surface of the lens sheet covering the flat portions and grooves.

### BACKGROUND OF THE INVENTION

1. Field of the Invention

The present invention relates to projection screens and particularly to transmission type projection screens.

2. Prior Art

In the prior art there exists transmission type projection screens. Such projection screens require that the light be projected from behind the screen and pass through the screen to be viewed by the audience on the other side. While such transmission type projection screens exist in the prior art, these projection screens have certain difficulties. In particular, they are low in resolution and contrast and do not efficiently spread the light projected therethrough to the viewer without either attenuating the light, scattering the light, providing stray light or creating hot spots or bands of light.

### SUMMARY OF THE INVENTION

In view of the above, it is a general object of the present invention to provide a transmission type projection screen which overcomes the disadvantages of the prior art.

In particular, it is an object of the present invention to provide a transmission type projection screen with enhanced resolution and contrast.

It is still another object of the present invention to provide a transmission type projection screen which effectively spreads the projected light over a wide field of view without creating apparent hot spots or bands of light.

It is yet another object of the present invention wherein the projected light to the viewer is sufficiently spread out while attenuating ambient light and unwanted stray light.

In keeping with the principles of the present invention, the objects are accomplished by a light transmission projection screen including a transparent lens sheet, a plurality of longitudinal spaced apart grooves provided in a front surface of the lens sheet, a plurality of flat portions (lenslets) in the front surface of the lens sheet with one each of the plurality of flat surfaces provided and separating each of the plurality of spaced apart grooves, a transparent optic layer provided only on an inner surface of each of the plurality of grooves with the refractive index of the transparent optic layer being less than the refractive index of the lens sheet, an optically opaque material filling only the plurality of grooves and a diffusion layer provided on the front surface of the lens sheet and over the plurality of flat portions and grooves. In addition and to protect the light transmission projection screen of the present invention, a thin layer of transparent material such as a plastic can be provided on top of the diffusion layer to protect the top surface of the diffusion layer and the screen from damage.

### DETAILED DESCRIPTION OF THE DRAWINGS

The above-mentioned features and objects of the present invention will become apparent with reference to the following description taken in conjunction with the accompanying drawings in which like reference numerals denote like elements and in which:

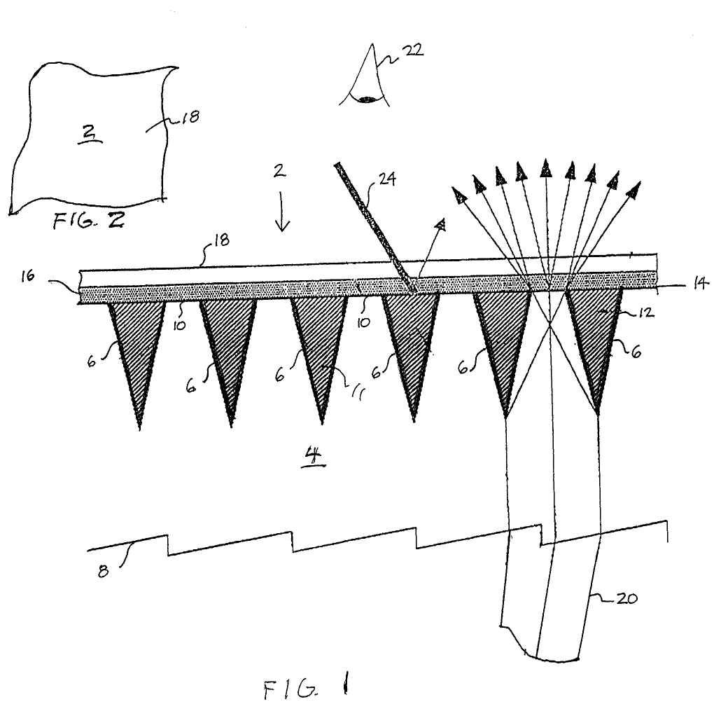

FIG. 1 is a cross-sectional view of a projection screen in accordance with the teachings of the present invention; and

FIG. 2 is a front view of a portion of the projection screen of FIG. 1.

### DETAILED DESCRIPTION OF THE INVENTION

Referring to FIGS. 1 and 2, shown therein are respectively a cross-sectional view of a projection screen 2 and a front view of a portion of the projection screen of FIG. 1. For the sake of clarity of explanation, the inventor would like point out that the cross-section of FIG. 1 is not provided with standard cross-sectional indications. The inventor respectfully submits that the application of such cross hatching would confuse the explanation of the invention and therefore have been omitted.

Looking at FIGS. 1 and 2, the projection screen 2 comprises a clear plastic sheet 4 made from a flexible transparent material having high visual light transmission. One such suitable plastic would be an acrylic such as polymethylmethacrylate (PMMA), however, other suitable plastics that have these characteristics could be utilized. On the front surface of the plastic sheet is provided a plurality of equally spaced apart V grooves 6 and the back surface of the plastic sheet 4 can be further provided with a Fresnel lens 8. However, while the function of the screen 2 can be enhanced by the use of the Fresnel lens 8, the screen 2 may be made without one. In between the V grooves 6 are provided flat areas or lenslets 10. The pitch of the lenslets 10 is determined by the resolution requirements of the image display. Assuming that a fixed array panel projector having a resolution of 1,024×1280 pixels and a projected image of 60″ wide has a pitch of 21.33 pixels per inch. The number of lenslets 10 per image pixel is selected so as to not seriously affect the resolution. In such a situation, the minimum number of lenslets 10 is approximately 3 per pixels or in this example about 63 lenslets 10 per inch. However, if more resolution is required, the number of lenslets 10 per pixel can be increased so that the number of lenslets 10 per inch could increase to 96, 144 or higher. The formulas for the depth of the grooves 6, the width of the grooves 6 and the width of the lenslets 10 are respectively set forth in formulas I, II and II below as follows:

P(tan θᵥ+tan(θᵥ/2)) (I)

2 tan(θᵥ/2)·P/(tan θᵥ+tan(θᵥ/2)) (II)

P−{2 tan(θᵥ/2)·P/(tan θᵥ+tan(θᵥ/2))} (III)

where P is the pitch and θᵥ is the included angle of the grooves 6.

The interior surfaces of the grooves 6 are coated with a layer 12 of a plastic material having a lower refractive index than the material of the sheet 4. The thickness of the layer is about seven (7) wavelengths of light or about 0.0002 inches. In the present invention, it is essential that substantially all of the projected light which impinges on the back surface of the projection screen and which further impinges on the surfaces of the grooves 6 be reflected out through the lenslets 10. In other words, substantially total internal reflection of all light which impinges on the grooves 6 is required. As a result, the slope of the grooves 6 together with the refractive indexes of the sheet 4 and the layers 12 is selected so that there is substantially total internal reflection and all of the lights which impinges on the surfaces of the grooves 6 is reflected out through the lenslet 10. In particular, the critical angle of light impinging on the surface of the groove 6 which would cause total internal reflection is equal to sin⁻¹ (n₂/n₁) wherein n₁ and n₂ are the respective refractive indexes of the sheet 4 and the layer 12. Typically, the critical angle to hit the surfaces of the V grooves 6 would be approximately 16.67 degrees or less if the refractive index of the sheet 4 is 1.49 and the refractive index of the layer 12 is 1.36. Accordingly, typical materials for layer 12 include a terpolymer of tetrafluoroethylene (TFE), hexafluoropropylene (HFP) and vinylidene fluoride (VF₂).

The grooves 6 with the layer 12 are then filled with an optically opaque material 11 such as a black plastic which is compatible with the layer 12. With the construction of the present invention, approximately 60% of the front surface 14 of the sheet 4 is black and it effectively absorbs ambient light.

The front surface 14 of the sheet 4 and the top surfaces of the grooves 6 are then covered by a diffusion layer 16. The diffusion layer 16 comprises an optically clear, durable and light stable layer filled with diffusion particles having a slightly different refractive index than that of the material from which the diffusion layer 16 is made. The preferred size of the diffusion particles is 2 to 5 microns and the diffusion particles in the diffusion layer 16 may be plastic beads such as polystyrene or polymethylmethacrylate or glass beads. The diffusion layer should be thick enough for suitable diffusion and minimization of light blowing but not too thick as to reduce or degrade the resolution. Typically, the diffusion layer 16 should be at least 0.004″ thick. Still further, the diffusion layer 16 can be made from many resins such as acrylics, urethanes and vinyls. In addition, it is desirable to provide diffusion particles in the sheet 4 since this would scatter the projected light into the opaque material 11 and reduce efficiency.

If it is desired to protect the projection screen 2 from damage to its front surface, an optically clear protective coating 18 can be applied thereto. The optically clear coating 18 can be made from any suitable optically clear resin which provides highly visible light transmission such as an acrylic. Still further, both the diffusion layer 16 and the protected layer 18 may be either cast onto the prior layer or made be formed separately and laminated onto the prior layer without an air layer or interface therebetween.

As to the optical Fresnel lens 8, the Fresnel lens 8 is for the purposes of focusing the light onto the surfaces of the V grooves 6 and the pitch of the Fresnel lenses is determined to minimize moire patterns. Still further, with longer throw projectors, i.e., 1.8:1 or longer, it may be desirable not to use a Fresnel lens 8. Also, the Fresnel lens 8 may also be provided separate and apart from the sheet 4 and similarly to the layers 16 and 18 be laminated onto the sheet 4. Finally, in some instances it may be desirable to provide a Fresnel lens in the front of the screen 2 toward the view 22.

In operation, the screen 2 functions substantially as a one way light transmissive optical device. In particular, when a projected light beam 20 impinges upon the Fresnel lens 8, it is focused onto the surfaces of the grooves 6. The light beams which impinge on the surfaces of the V grooves 6 at greater than the critical angle would be reflected out through the lenslets 10 and diffused by the diffusion layer 16 and ultimately viewed by the eye of the viewer 22. Any stray light which does not hit the surfaces the V grooves 6 at greater than a critical angle will pass through the surfaces of the V grooves 6 and the layer 12 and be absorbed by the optically opaque material 11 provided in the V grooves 6. Still further, any stray ambient light such as 24 which strikes the surface of the screen 2 and particularly the portion of the screen 2 containing the V grooves 6 filled with optically opaque material are substantially absorbed and reflected off at angles which are not viewed by the viewer 22. Still further, typically in the screen 2 of the present invention, two-thirds of the projected light rays that exit from the lenslets 10 are at an angle greater than ±30 degrees from the normal. Also, the diffusion layer 16 blends the light output into a uniform spread across the vertical and horizontal axis and the half gain angles across the vertical axis are typically greater than substantially ±20 degrees and the half gain angles across the horizontal axis are typically greater than substantially ±50 degrees with a peak gain at normal greater than 2.

It should be apparent to those skilled in the art that the construction and operation of the present invention achieves the objects of the present invention. It should be further apparent to those skilled in the art that numerous and other arrangements can be achieved without departing from the spirit and scope of the present invention.

I claim:

1. A light transmission projection screen comprising:
a transparent lens sheet;
a plurality of longitudinal spaced apart grooves provided in a front surface of said lens sheet;
a plurality of flat portions in said front surface of said lens sheet, one each of said plurality of flat surfaces being provided between and separating each of said plurality of spaced apart grooves;
a transparent optical layer provided only at an inner surface of each of said plurality of grooves, said transparent optical layer having a refractive index less than a refractive index of said lens sheet;
an optically opaque material filling only said plurality of grooves; and
a diffusion layer provided on said front surface of said lens sheet and over said plurality of flat portions and grooves.

2. The light transmission projection screen according to claim 1, further comprising a protective coating over said diffusion layer.

3. The light transmission projection screen according to claim 1, further comprising a Fresnel lens provided behind the transparent lens sheet.

4. A light transmission projection screen according to claim 1, wherein said diffusion layer comprises a transparent material and diffusion particles.

5. The light transmission projection screen according to claim 3, wherein said diffusion layer comprises a transparent material and diffusion particles.

6. The light transmission projection screen according to claim 2, further comprising a Fresnel lens provided behind said transparent lens sheet.

7. The light transmission projection screen according to claim 1, wherein said lens sheet is made from acrylic.

8. The light transmission projection screen according to claim 7, wherein said acrylic is a polymethylmethacrylate.

9. The light transmission projection screen according to claim 1, wherein a refractive index of the lens sheet is substantially equal to 1.49 and a refractive index of the optical layer is substantially equal to 1.36.

10. The light transmission projection screen according to claim 8, wherein the transparent optical layer is made from a material selected from the group consisting of a terpolymer of tetrafluoroethylene, hexafluoropropylene and vinylidene fluoride.
